(19) United States
(12) Patent Application Publication
(10) Pub. No.: US 2012/0000349 A1
(43) Pub. Date: Jan. 5, 2012

(54) ASSIGNING WEAPONS TO THREATS

(75) Inventors: Nicolas Couronneau, Bristol (GB); David Nicholson, Bristol (GB); Jordi McGregor Barr, Bristol (GB); Mark Stephen Rowan, Buckinghamshire (GB)

(73) Assignee: BAE SYSTEMS plc, London (GB)

(21) Appl. No.: 13/256,025

(22) PCT Filed: Mar. 29, 2010
(86) PCT No.: PCT/GB10/50530

§ 371 Date: Sep. 12, 2011

(30) Foreign Application Priority Data
Mar. 31, 2009 (EP) 09250985.0
Mar. 31, 2009 (GB) 0905563.3

(51) Int. Cl. G06Q 10/00

(52) U.S. Cl. 89/1.11

(57) ABSTRACT

System and method of assigning at least one weapon of a plurality of weapons to at least one threat of a plurality of threats. Data relating to a plurality of weapons and threats data relating to a plurality of threats is received and processed to select at least one of a plurality of weapons assignment techniques. The selected weapons assignment technique is applied to the data to produce data describing assignment of at least one of the plurality of weapons to at least one of the plurality of threats.

The present invention relates to assigning weapons to threats.

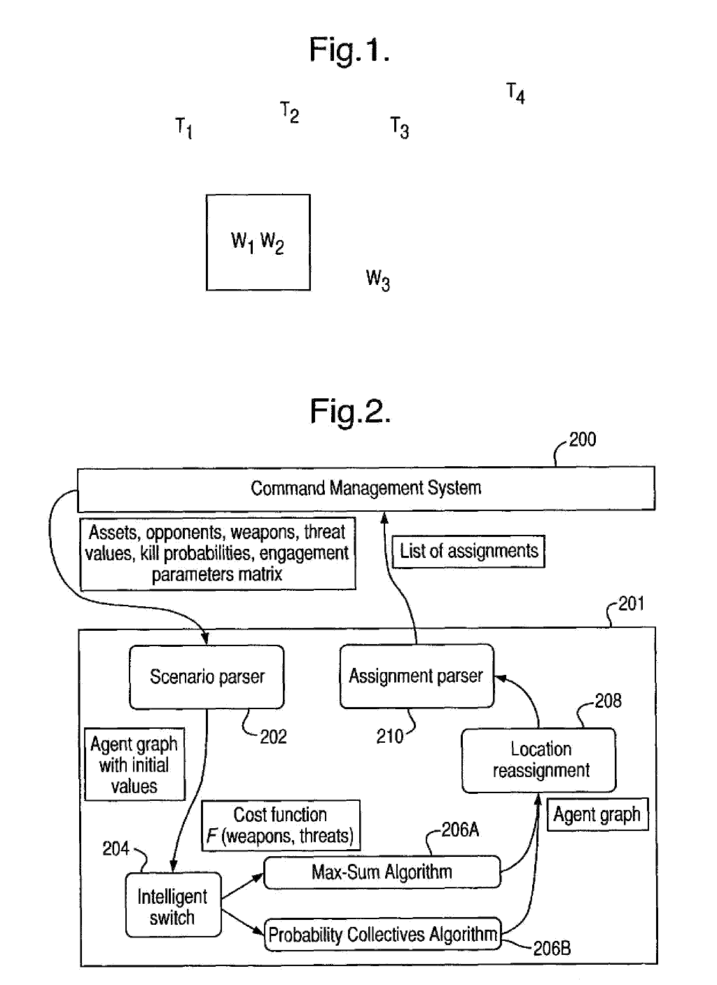

FIG. 1 is a schematic illustration of a hostile environment/battlespace including a plurality of weapons and threats. In the example there are three weapons W1, W2, W3 and four threats T1, T2, T3, T4. A battlespace can be thought of as a set of assets with weapons for countering a set of threats. An asset may be associated with/have one or more weapons, e.g. W1 and W2 in the Figure are co-located on the same asset. For instance, the asset may include a vehicle such as a submarine having different types of weapons, e.g. torpedoes with different payloads, or tanks. Alternatively, an asset may include a static structure, e.g. a missile launch base, or even a troop of soldiers. Weapons (and the firing of them) have associated values/costs, the units of which can be monetary, tactical, or some other. Threats have the potential to cause damage to assets and defended areas. The units of these defended assets can be monetary, tactical, etc. Success in a battlespace requires good allocation of weapons to threats. This is a balance between minimising losses by using more and better weapons to effect a maximal amount of damage whilst retaining some weapons for later use. However, the effectiveness of a weapon can vary according to the threat it faces, the dynamics of the platform it resides upon, or any number of other complicating factors.

Existing solutions to the problem of how to assign weapons to threats are normally explicitly formulated as a single central process, i.e. suitable for single assets only. With multiple assets executing local assignment plans, suboptimal performance is encountered due to the possibility of the same threat being engaged by more than one weapon when that is unnecessary, or a threat not being engaged by any weapon.

Embodiments of the present invention are intended to address at least some of the problems discussed above and can result in efficient computation of an assignment solution distributed across a number of weapons platforms.

According to one aspect of the present invention there is provided a method of assigning at least one weapon of a plurality of weapons to at least one threat of a plurality of threats, the method including:

receiving weapons data relating to a plurality of weapons;

receiving threats data relating to a plurality of threats;

processing the weapons data and the threats data to select at least one of a plurality of weapons assignment techniques, and

applying the at least one selected weapons assignment technique to produce data describing assignment of at least one of the plurality of weapons to at least one of the plurality of threats.

The weapons assignment techniques may be selected from a set including: a Max Sum technique, a Random Neural Network technique and/or a Probability Collectives-based technique.

The weapons data may include data representing a cost of using each said weapon. The threats data may include data representing a cost associated with each said threat, the cost typically being a measure of potential damage causable by each said threat. The use costs in the weapons data and the use costs in the threats data will normally be expressed in identical units. The weapons and/or threats data may be output by a threat evaluation process.

The method can further include a step of receiving user input/parameter(s) and processing the user input/parameter(s) as part of the selection of the at least one weapons assignment technique. The user input/parameter(s) may relate to weapon accuracy or weapon use timing.

The method may include further analysing the data describing the assignment produced by the applying of the at least one selected weapon assignment technique and modifying the data describing the assignment. The further analysis may include checking use of the assigned weapons for a cross-fire state, and modifying the data describing the assignment so that the cross-fire state is avoided. The analysis may include checking appropriateness of a said assigned weapon(s) for use with the threat to which the weapon(s) has been assigned, and modifying the data describing the assignment if the weapon(s) is not appropriate. The analysis may include checking geographical proximity of a said assigned weapon(s) to the threat to which the weapon(s) has been assigned, and modifying the data describing the assignment to assign another to the threat if the assigned weapon is not the weapon that is geographically closest to the threat.

According to another aspect of the present invention there is provided a system configured to assign at least one weapon of a plurality of weapons to at least one threat of a plurality of threats, the system including:

a component for receiving weapons data relating to a plurality of weapons;

a component for receiving threats data relating to a plurality of threats;

a processor component for:
processing the weapons data and the threats data to select at least one of a plurality of weapons assignment techniques, and
applying the at least one selected weapons assignment technique to produce data describing assignment of at least one of the plurality of weapons to at least one of the plurality of threats.

According to another aspect of the present invention there is provided a computer program product comprising computer readable medium, having thereon computer program code means, when the program code is loaded, to make the computer execute a method of assigning at least one weapon of a plurality of weapons to at least one threat of a plurality of threats substantially as described herein.

According to yet another aspect of the present invention there is provided a method of assigning at least one weapon of a plurality of weapons to at least one threat of a plurality of threats, the method including:

receiving weapons data relating to a plurality of weapons;

receiving threats data relating to a plurality of threats;

applying a Max-Sum and/or Random Neural Network and/or PC-based weapons assignment algorithm to produce data describing assignment of at least one of the plurality of weapons to at least one of the plurality of threats.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

FIG. 1 is a schematic diagram of a plurality of weapons and threats;

FIG. 2 is a schematic diagram of a system configured to assign weapons to threats, and

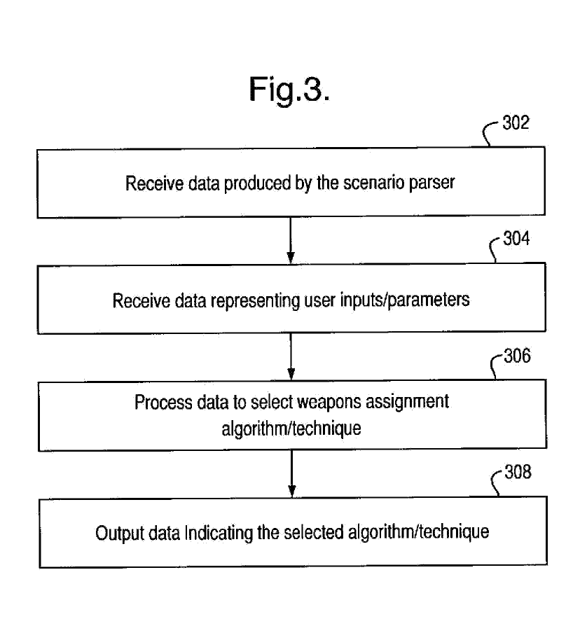

FIG. 3 illustrates schematically steps performed by a switch component of the system of FIG. 2.

Referring to FIG. 1 again, the problem posed is which weapon(s) to assign to which of the threats. Data can be produced describing characteristics of each asset, e.g. geographic location, speed, weapon fit. The weapon fit of an asset is specified by the types of weapon it has available, the cost (monetary or otherwise) of firing a particular weapon type, and the number of weapons of each type. It will be appreciated that the number, types and characteristics of the assets described herein are exemplary only.

Data specifying characteristics of each threat can also be produced. For instance, each threat may have associated with it a geographic location, a bearing, a speed and a score. The score (in units commensurate with the cost of firing a weapon) defines the value of the threat in terms of its capability to cause damage to the assets. For example, a cheap cruise missile may be more threatening than an expensive transport aircraft. These scores will normally be an output of a threat evaluation process that may be performed by human assessors reviewing the scenario/battlespace, or may at least be partially retrieved from a data store or automatically calculated based on known information about at least some of the threats.

Referring to FIG. 2, a command management system 200 is shown in communication with a weapons assignment component 201. The command management system may be, for example, the CMS-1 produced by BAE Systems. That system can visualise situational awareness in a ship-based air defence scenario to render data (geography, location of threats, location of assets, etc) for an operator on the bridge of a ship. More generally, the management system can comprise any (dynamic) data storage and visualisation system that is able to feed the location of assets (weapons), threats, threat levels, rules of engagement/standing orders, and other relevant matters, to an operator in order to provide the best “view” of the battlespace. The system can be partially automated and may receive inputs from radars/cameras for detection, threat evaluation modules, weapons, health monitoring, etc. The component 201 can include a computing device having a processor and internal memory configured to execute steps as described herein. The component 201 receives the data describing the weapons and the threats from the management system 200 and process that data in order to provide the system 200 with a list of assignments, i.e. which weapons are to be used against which threats, which can be thought of as the solution to the weapons assignment problem.

The weapons assignment problem can be formulated as a graph with weapons connected to threats to which they can be assigned. A cost function can be created that reflects the costs of assigning weapons to threats with the potential to cause a specified amount of damage. The units of this function can be user-selected, e.g. monetary or casualty/safety-based. The component 201 is capable of executing more than one type of allocation algorithm/technique and the decision regarding which algorithm to use is made by an “intelligent switch” process, which can take into account parameters (e.g. number of weapons, time constraints, etc.) that may have been chosen by an operator. The algorithm outputs data representing an assignment and a reassignment check can then be performed made to try to ensure that the best (e.g. geographically closest) weapon of the type specified in the assignment is assigned to its threat.

The data is first received by a scenario parser process 202 executing on the component 201. The general weapons assignment problem can be formulated as a nonlinear integer programming problem and is known to be NP-complete. A further input used by the process is an engagement parameter matrix. The (V″ element of this matrix is the probability pᵢⱼ of destroying target j by a single weapon of type i. Then qᵢⱼ=1−pᵢⱼ denotes the probability of survival of target j if it gets assigned by a single weapon of type i.

Now, if xᵢⱼ is the number of weapons of type i assigned to target j, then the survival probability of target j is given by qᵢⱼ^{x}^{ᵢⱼ}. A target may be assigned weapons of different types. The weapons assignment problem is to determine the xᵢⱼ values that minimise the expected survival value of all targets.

Formally, let N be the number of targets, M the number of weapon types, Cⱼ the cost of damage caused by target j, Cᵢ the cost of firing weapon type i, and Wᵢ the number of weapons of type i available to be assigned to targets. The following nonlinear integer programming problem must be solved:

$$Minimise {\sum }_{i = 1}^{N} {C}_{i} + {\sum }_{j = 1}^{M} {C}_{j} {\prod }_{i = 1}^{N} {q}_{ij}^{{x}_{ij}}$$

subject to

$${\sum }_{j = 1}^{N} {x}_{ij} \leq {W}_{i} ,$$

for all i=1, 2, . . . , M

xᵢⱼ≧0 and integer, for all i=1, 2, . . . , M and for all j=1, 2, . . . , N

This formulation expresses an objective to minimise the expected cost of an engagement plan while ensuring the total number of weapons used is no more than those available. The scenario parser 202 effectively processes the data it receives in order to formulate a cost function that can be used by the weapons assignment techniques described below and also by an intelligent switch 204.

FIG. 3 illustrates steps that provide the intelligent switch functionality. At step 302 data produced by the scenario parser 202 is received. At step 304 data representing user inputs/parameters may be received. Step 304 may not be performed by all embodiments of the system, but can be useful when at least one additional/variable factor, such as the desired accuracy level of a weapon, the amount of computational power available and/or a “time to launch” constraint, etc, need be taken into account.

At step 306 the data received at step 302 (and, optionally, step 304) is processed in order to select a weapons assignment algorithm/technique in combination with data describing characteristics of the algorithms/techniques that are available. It will be appreciated that this step can involve various types of computations. For example, if the user-defined parameter specifies a certain time frame for producing the weapons assignment then the step can include selecting an algorithm/technique that is expected to produce a result within that time frame. Alternatively, if no time constraint has been specified then the step may select the algorithm/technique that is expected to produce the most effective assignment. In another case, the complexity of the cost function may be taken into account and any algorithm/technique not capable of dealing with that level of complexity is eliminated. At step 308 data indicating the algorithm/technique selected is output. It will be appreciated that in some cases more than one algorithm/technique may be selected, e.g. for results comparison during testing.

Items 206A and 206B of FIG. 2 represent two different weapons assignment algorithms/techniques, one of which will normally be selected by the intelligent switch 204. It will be appreciated that the type and number of algorithms/techniques shown is exemplary only and in alternative embodiments more than two may be available. For example, a Random Neural Network (RNN) based technique (see Gelenbe E & Thimotheou S. 2008, NEURAL COMPIT, 20, 2308-2324) could also be offered in addition to (or instead of one of) the two techniques shown in FIG. 2. A description of the two illustrated algorithms/techniques will now be given:

### Max-Sum Algorithm 206A

The basis of the Max-Sum algorithm is to represent a global cost or utility function as a factor graph and then to optimise it in a decentralised manner via local message passing. In order to construct the graph, an agent is represented as a function with a variable representing its state and utility. An agent may be used to represent a decision maker and can be ascribed to an asset. A set of interacting agents is known as a Multi-Agent System (MAS). MAS can employ Game Theory to develop interaction strategies for agent-negotiation that lead to equilibrium solutions for multi-agent decision making and resource management. The utility of any agent is a function of its own state and the state of a small number of neighbouring agents. Thus, the function node of a single agent is connected to its own variable node, and the variable nodes of a number of neighbouring agents. Given the factor graph, the Max-Sum algorithm calculates the messages that should be exchanged between the agents to maximise the global utility.

The Max-Sum algorithm can have good scaling properties because the largest calculation any agent performs is exponential only in its number of neighbours, which is typically much less than the total number of agents in the system. The algorithm involves transmitting and updating messages between neighbouring agents until the states of all agents converge to fixed states that represent either the optimal solution, or a solution that is close to optimal.

In applying the Max-Sum algorithm to the problem, a key question is how the global cost function (i.e. the expected cost of an engagement plan) depends on the actions of the individual agents (i.e. the assignment of weapons to targets). If the global cost can be factored, scalable decentralised solutions should be possible. If it cannot be factored, solutions may still be available but they will not be scalable. Other key issues are the convergence time of the algorithm and the quality of the solution to which the algorithm converges. The results are likely to be strongly scenario-dependent.

### Probability Collectives (206B)

The basis of Probability Collectives (PC)-based algorithm is that each agent is to manipulate a probability distribution over its actions rather than the actions directly. This provides a scalable decentralised solution to optimisation problems that is robust under uncertainty and is amenable to standard gradient descent techniques in spite of the discrete nature of the actions. PC is a broad framework for analysing and controlling distributed systems (see D. H. Wolpert, Collective Intelligence, Computational Intelligence Beyond 2001: Real and Imagined, Wiley, 2001). The algorithm proceeds by each asset initialising the probability distribution over its actions, typically a uniform distribution. The assets then draw a sample block from their distributions and communicate it to an ‘oracle’, e.g. a battle command station. The oracle processes these samples and transmits a reward back to the asset. The assets exploit this reward to update their probability distributions, and then the process repeats. The expectation is that each asset's probability distribution will eventually become ‘peaked’ around its optimal action.

The PC-based algorithm is explicitly decentralised because the assets are running separate computer programs and only interacting with each other via the oracle. The main communication overhead in PC is the transmission of sample blocks from the agents to the oracle. The size of these blocks will be problem dependent as will the number of communications with the oracle that are required before the solution converges.

The output of the selected algorithm is data describing a weapons-to-threats assignment, e.g. in the form of a matrix. The component 201 includes an optional process 208 for checking the assignment and possibly modifying it before it is transferred to the command management system 200. The process 208 can involve performing checks based on the data received by the scenario parser 202 and/or other parameter data provided by a user. The intention is to check that the assignment does not result in illogical or even dangerous weapons use on a practical level. It will be appreciated that this process can involve various types of computations. For example, data representing the geographical location of the weapons and threats (which may not be taken into account the weapons assignment algorithms 206A, 206B) can be processed to check if there is a weapon of the same type as specified by the assignment located nearer the assigned threat than the one specified in the assignment. If so then the process 208 can modify the assignment data to allocate the geographically-closer weapon to the threat. Additionally or alternatively, the process may involve computing if firing the weapons in accordance with the assignment will result in harmful cross-fire and, if so, amend the assignment to avoid that situation.

The assignment data (possibly modified by process 208) is then transferred to an assignment parser process 210 that set the assignment data into a format that can be directly used by the command management system 200. Upon receipt of the assignment, the system 200 can implement it, e.g. by direct remote control of the weapons and/or by informing a controller of an asset of which threat its weapon(s) is to target.

1. A method of assigning at least one weapon of a plurality of weapons to at least one threat of a plurality of threats, the method comprising:
receiving weapons data relating to a plurality of weapons;
receiving threats data relating to a plurality of threats;
processing the weapons data and the threats data to select at least one of a plurality of weapons assignment techniques; and
applying the at least one selected weapons assignment technique to produce data describing assignment of at least one of the plurality of weapons to at least one of the plurality of threats.

2. A method according to claim 1, wherein the weapons assignment techniques are selected from a set including: a Max Sum technique, a Random Neural Network technique and/or a Probability Collectives-based technique.

3. A method according to claim 1, wherein the weapons data includes data representing a cost of using each said weapon and the threats data includes data representing a cost associated with each said threat, the cost in the threats data representing a measure of potential damage causable by the threat.

4. A method according to claim 3, wherein the use costs in the weapons data and the costs in the threats data are expressed in identical units.

5. A method according to claim 1, wherein the weapons data and/or threats data is an output of a threat evaluation process.

6. A method according to claim 2, including:
receiving user input/parameter(s) and processing the user input/parameter(s) as part of the selection of the at least one weapons assignment technique.

7. A method according to claim 6, wherein the user input/parameter(s) relates to weapon accuracy, or weapon use timing.

8. A method according to claim 1, including:
analyzing the data describing the assignment produced by the applying of the at least one selected weapon assignment technique, and modifying the data describing the assignment.

9. A method according to claim 8, wherein the analyzing includes:
checking use of the assigned weapons for a cross-fire state, and modifying the data describing the assignment so that the cross-fire state is avoided.

10. A method according to claim 8, wherein the analyzing includes:
checking appropriateness of said assigned weapon(s) for use with the threat to which the weapon(s) has been assigned, and modifying the data describing the assignment when the weapon(s) is not appropriate.

11. A method according to claim 8, wherein the analyzing includes:
checking geographical proximity of said assigned weapon(s) to the threat to which the weapon(s) has been assigned, and modifying the data describing the assignment to assign another weapon to the threat when the assigned weapon is not a weapon that is geographically closest to the threat.

12. A system configured to assign at least one weapon of a plurality of weapons to at least one threat of a plurality of threats, the system comprising:
a component for receiving weapons data relating to a plurality of weapons;
a component for receiving threats data relating to a plurality of threats;
a processor component configured to:
process the weapons data and the threats data to select at least one of a plurality of weapons assignment techniques; and
apply the at least one selected weapons assignment technique to produce data describing assignment of at least one of the plurality of weapons to at least one of the plurality of threats.

13. A computer program product comprising a tangible computer readable medium, having thereon computer program code which, when the program code is loaded into a computer, will cause the computer to execute a method of assigning at least one weapon of a plurality of weapons to at least one threat of a plurality of threats, the method comprising:
receiving weapons data relating to a plurality of weapons;
receiving threats data relating to a plurality of threats;
processing the weapons data and the threats data to select at least one of a plurality of weapons assignment techniques; and
applying the at least one selected weapons assignment technique to produce data describing assignment of at least one of the plurality of weapons to at least one of the plurality of threats.
